(19) United States
(12) Patent Application Publication
(10) Pub. No.: US 2005/0223903 A1
(43) Pub. Date: Oct. 13, 2005

(54) Coffee filter ring

(76) Inventor: Richard I. McDaniel, Indianapolis, IN (US)

Correspondence Address: Clifford W. Browning;Suite 3700, 111 Monument Circle, Indianapolis, IN, 46204-5137, US

(21) Appl. No.: 11/093,212

(22) Filed: Mar. 29, 2005

Related U.S. Application Data
(60) Provisional application No. 60/560,103, filed on Apr. 7, 2004.

(51) Int. Cl. A47J 31/00

(52) U.S. Cl. 99/279

(57) ABSTRACT

A coffee filter ring that comprises a retaining ring adapted to fit within the coffee filter paper in the coffee basket of a conventional automatic drip coffee maker. The ring is sized and shaped so that it can be placed on top of a second filter paper and holds the second filter paper in place essentially sealing off the coffee grounds being held by the first coffee filter paper, thereby preventing the coffee grounds from spilling out of the coffee filter basket into the coffee pot while the coffee maker is brewing the coffee. The coffee filter ring is sized and shaped to fit the middle to lower portion of the filter basket and is split with an outward springing action to enable it to adapt to the size of the basket and conform to the coffee filter papers and coffee grounds as they become moist from the hot water from the automatic dripping system.

This application claims the priority benefit of U.S. Provisional Patent Application Ser. No. 60/560,103, filed Apr. 7, 2004.

The present invention relates generally to coffee filter papers for automatic drip coffee makers with coffee brewing baskets, and more particularly to devices inserted within the coffee brewing basket to sandwich coffee grounds between two coffee filter papers and to thereby secure the coffee filter papers and the coffee grounds at the bottom of the coffee brewing basket to thereby prevent the overflow of the coffee grounds into the coffee pot of an automatic drip coffee maker.

### SUMMARY OF THE INVENTION

Most automatic drip coffee makers have a coffee brewing basket that requires a coffee filter paper to hold the coffee grounds and to prevent the coffee grounds from flowing into the coffee pot through the drain hole in the bottom of the basket. There is a recognized problem of coffee grounds spilling into the coffee pot during brewing when one attempts to brew the near capacity volume of the coffee maker as a result of the coffee filter paper drooping or as a result of the coffee grounds overflowing the sides of the coffee filter paper. There are devices in the prior art that address the drooping of the coffee filter paper by holding the filter paper in its intended place within the brewing basket. However, even with these devices, when one attempts to brew at the near capacity volume of the coffee maker, often times the coffee grounds will migrate up the walls of the coffee filter paper and overflow the sides of the paper filter and the brewing basket and wash into the coffee pot. By adding a second filter paper on top of the first filter paper (that is holding the coffee grounds), and positioning a fixable ring to hold the second filter paper in place atop the first filter paper, which sandwiches the coffee grounds between two filter papers at the middle to lower portion of the brewing basket, the coffee grounds are secured in the bottom of the brewing basket and are sealed off, thereby prohibiting the coffee grounds from escaping and being washed into the coffee pot.

One of the forms of the coffee filter ring of the present invention is designed to be used with a coffee basket that is circular in shape. The coffee filter ring is split and sizes itself to conform to the circumference of the lower portion of the coffee basket. The material of the coffee filter ring could be of a plastic that is tolerant of the high brewing temperatures of the coffee maker water and also has an outward springing action. The coffee filter ring could have notches at one end at one-half inch intervals whereby the user could trim the coffee filter ring to conform to the user's specific coffee maker basket size, so that one size would fit all. Some adjustment of the length of the coffee filter ring could be necessary by the user to make the coffee filter ring conform to the different brewing capacity coffee makers now available. It could also be made of other materials such as stainless steel, or the like that have the high temperature tolerance and an outward springing action.

Another form of the coffee filter ring of the present invention to be used with coffee baskets that are circular in shape would be a solid ring donut that conforms to the bottom of the brewing basket. The material of this coffee filter ring could be glass or ceramic or the like that would be tolerant of the high brewing temperatures of the coffee maker and have a weight sufficient to hold the second coffee filter paper in its proper place over the top of the coffee grounds and to position the coffee filter ring at the sides of the brewing basket. The opening in the middle of the coffee filter ring would be sufficient to allow appropriate amounts of hot water to pass through the filters to effectively brew coffee from the grounds in the brewing basket. In this form the coffee filter ring would have to be sized and shaped to fit a particular coffee maker brewing basket.

### BRIEF DESCRIPTION OF THE DRAWINGS

FIG. 1 is a perspective view of one embodiment of the coffee filter ring of the present invention.

FIG. 2 is an exploded perspective view of a coffee maker's brewing basket, top coffee paper filter, bottom coffee paper filter, and one embodiment of the coffee filter ring of the present invention.

FIG. 3 is a perspective view of another embodiment (solid ring) of the coffee filter ring.

FIG. 4 is a fragmentary cross-sectional illustration of a coffee filter basket, bottom coffee paper filter, coffee grounds, top coffee paper filter, and one embodiment of the coffee filter ring of the present invention.

### DESCRIPTION OF THE PREFERRED EMBODIMENTS

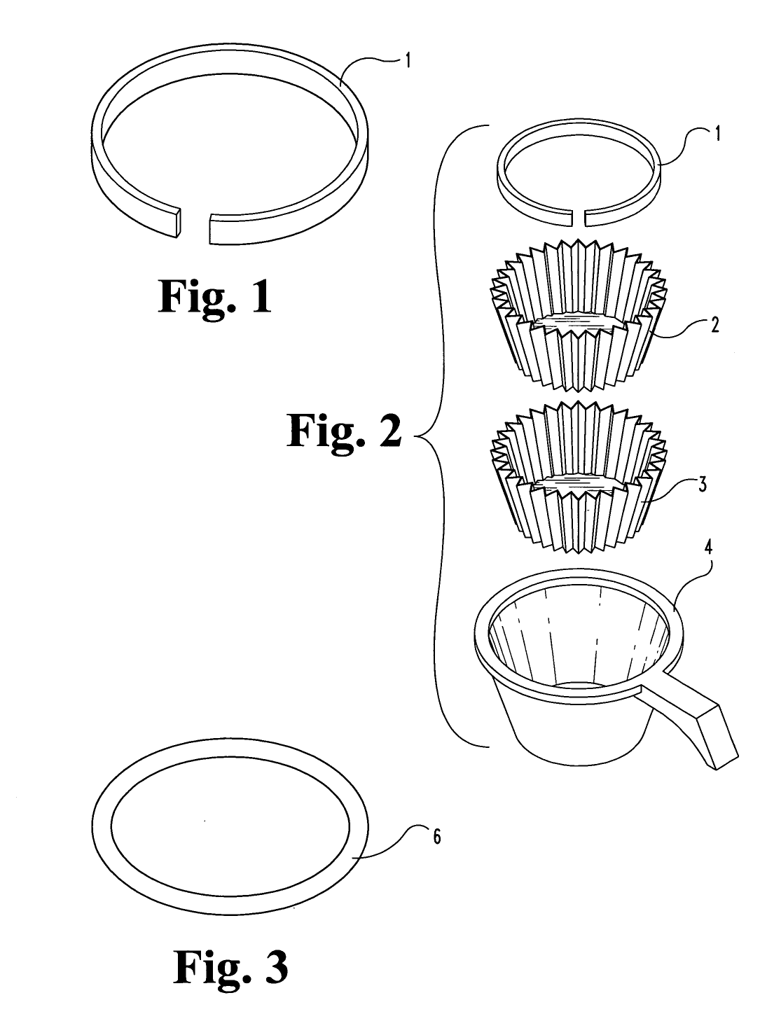

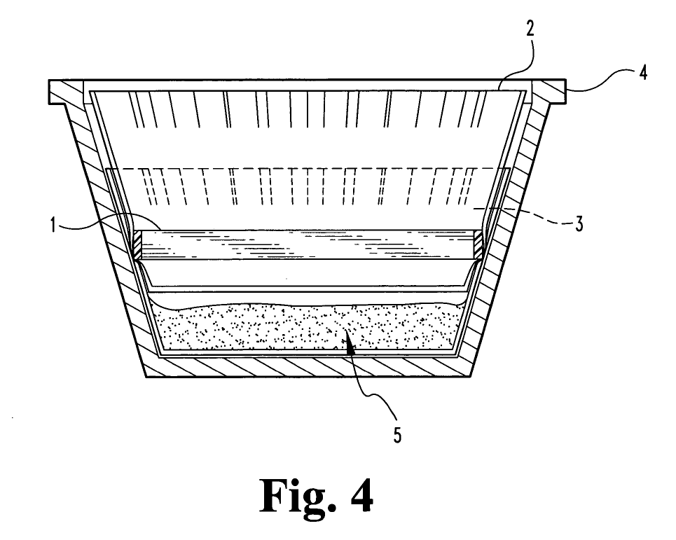

FIG. 1 is a perspective view of an exemplary embodiment of the coffee filter ring 1 of the present invention. FIG. 2 is an exploded perspective view of a coffee maker's brewing basket 4, top coffee paper filter 2, bottom coffee filter paper 3, and one embodiment of the coffee filter ring 1. The bottom coffee filter paper 3 is placed in the brewing basket 4. The coffee grounds 5 are placed on the coffee filter paper 3 and are sufficiently agitated to smooth the coffee grounds out to a uniform depth. The top coffee filter paper 2 is placed inside the bottom coffee filter paper 3 and on top of the coffee grounds 5 and is pressed down to conform to the bottom of the coffee brewing basket 4. The coffee filter ring 1 is then placed inside the top filter paper 2 and is pressed down to secure its position toward the bottom of the brewing basket 4 and so that its outward springing action sandwiches both coffee filter papers 2, 3 between the ring and the sides of the brewing basket 4. As the hot water dripping action of the coffee maker moistens the coffee filter papers 2, 3, the coffee filter ring 1 will expand to conform to the coffee brewing basket 4 and press the two coffee filter papers 2, 3 together thereby sealing the coffee grounds 5 in between the two coffee filter papers 2, 3 and the sidewalls of the brewing basket 4, thereby preventing coffee grounds 5 from escaping into the coffee pot by overflowing the brewing basket 4.

FIG. 3 is a description of the solid coffee filter ring 6. Its design is to conform to the size and shape of a specific coffee brewing basket 4. The application of the solid coffee filter ring 6 is similar to the split coffee filter ring 1 except that the weight and size of the solid coffee filter ring 6 is used to seal the two coffee filter papers 2, 3 together and to the sides of the brewing basket 4 in order to prevent the escape of the coffee grounds 5.

1. A method for brewing coffee in an automatic drip coffee maker having a coffee brewing basket, comprising the steps of:
placing a first coffee filter paper in the coffee brewing basket;
adding coffee grounds to the first coffee filter within the coffee brewing basket to a substantially uniform depth;
placing a second coffee filter in the coffee brewing basket within the first coffee filter paper and atop the coffee grounds;
positioning a coffee filter ring within the second coffee filter to hold the second coffee filter atop the coffee grounds and in position within the coffee brewing basket.

2. The method of claim 1 wherein the coffee filter ring expands outwardly against the coffee brewing basket to hold the second coffee filter atop the coffee grounds and in position within the coffee brewing basket.

3. The method of claim 1 wherein the coffee filter ring is sized to hold the second coffee filter atop the coffee grounds and in position within and against the coffee brewing basket by its weight alone.
